(19) United States
(12) Patent Application Publication
(10) Pub. No.: US 2013/0113903 A1
(43) Pub. Date: May 9, 2013

(54) IMAGE MAGNIFICATION METHOD AND APPARATUS

(71) Applicants: Mihal Lazaridis, Waterloo (CA); Brent Andrew Ellis, Waterloo (CA)

(72) Inventors: Mihal Lazaridis, Waterloo (CA); Brent Andrew Ellis, Waterloo (CA)

(73) Assignee: RESEARCH IN MOTION LIMITED, Waterloo (CA)

(21) Appl. No.: 13/289,109

(22) Filed: Nov. 4, 2011

(51) Int. Cl. H04N 7/18

(52) U.S. Cl. 348/63; 348/E07.085

(57) ABSTRACT

A magnifying method is provided in which a mobile communication device is configured to: decrease an active resolution of an imaging module of the mobile communication device while imaging an item; process the decreased active resolution being output by the imaging module to produce a magnified image of the portion of the item; increase a scaling factor of the magnified image to further magnify the magnified image; and output frames for displaying a magnified version of the portion of the item.

### TECHNICAL FIELD

The present disclosure relates generally to digital imaging. More particularly the present disclosure relates to an image magnification method and apparatus.

### BACKGROUND

The concept of accessibility relates to providing accommodations to individuals with disabilities. In some instances laws or regulations have improved access for disabled individuals to facilities or amenities including housing, transportation and telecommunications. Furthermore, accessibility is becoming more relevant with regard to improving quality of life for a growing demographic of individuals who are not disabled per se but who instead suffer from lesser impairments or difficulties such as partial hearing loss or low vision.

Mobile electronic devices (e.g., including cell/smart phones, personal digital assistants (PDAs), portable music/media players, tablet computers, etc.) typically include cameras or camera modules that are capable of enlarging text or images by performing a conventional imaging operation known as “digital zoom” (during which an image is cropped, and a result of the cropping is magnified). However, digital zoom relies on an interpolation process which makes up, fabricates or estimates intermediate pixel values to add to the magnified image, and therefore a digital zoomed image typically suffers from decreased image quality. That is, digital zoomed, interpolated images exhibit aliasing, blurring and edge halos for example. To this end, digital zoom, in and of itself, is not useful for assisting individuals with low vision.

### BRIEF DESCRIPTION OF THE DRAWINGS

FIG. 1 illustrates one imaging operation of an example image magnification method;

FIG. 2 illustrates another operation of the example image magnification method;

FIG. 3 illustrates an example output resulting from the present image magnification method; and

FIG. 4 illustrates a block diagram of an example mobile electronic device configured to perform the present image magnification method.

### DETAILED DESCRIPTION

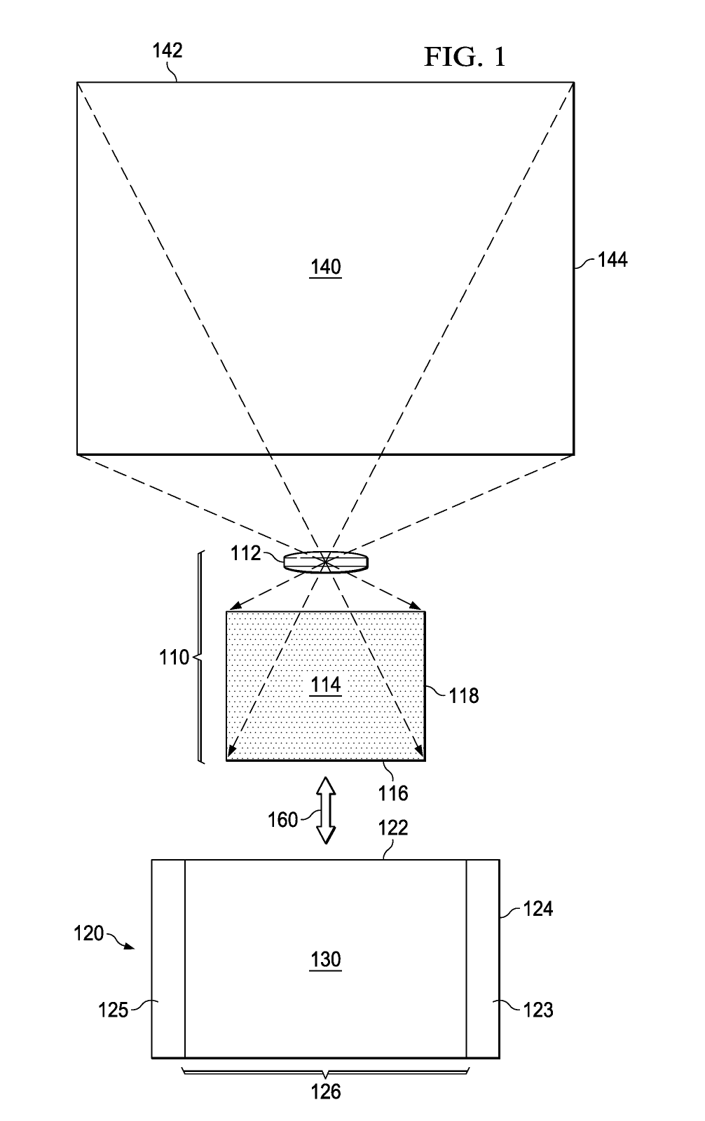

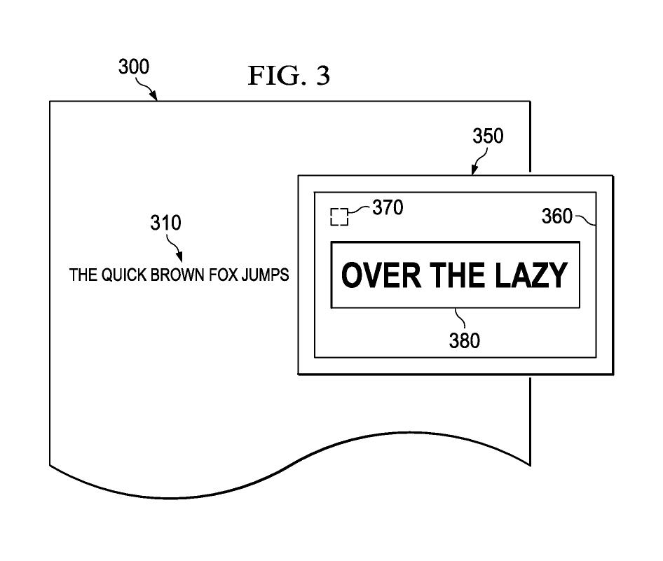

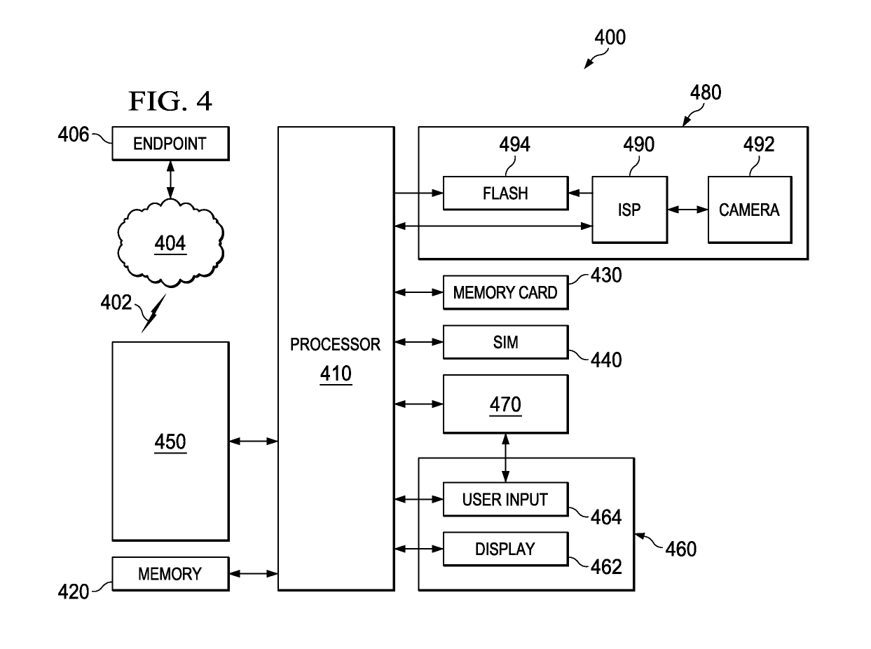

Referring now to the Figures, example apparatuses and methods for magnifying an item are described. FIG. 1 shows one operation of the present image magnification method. The operation of FIG. 1, which in some instances may be a conventional imaging operation, is performed by a mobile electronic device that includes a camera module 110 and a display 120. The imaging operation of FIG. 1 can be considered as a baseline operation that provides a reference against which magnification is measured or quantified. Although the mobile electronic device will be described in further detail with respect to FIGS. 3 and 4, as shown in FIG. 1 the camera module 110 of the mobile electronic device includes a lens 112 or lenses and an image sensor 114. The operation shown in FIG. 1 involves controlling or otherwise using the camera module 110 for generating an initial image of an item 140, object or scene in order to reproduce the image of the item 140 on the display 120. For sake of simplicity, the item 140 being imaged is shown to have a rectangular configuration with a first side 142 along a first direction or axis (e.g., horizontal direction, x-axis) and a second side 144 along a second direction or axis (e.g., vertical direction, y-axis). When imaging the item 140, the lens 112 of the camera module 110 focuses light reflected from the item 140 onto the image sensor 114. As indicated by the hatching shown on the image sensor 114, a substantial entirety of the surface area of the imaging sensor 114 is active and being exposed to the light reflected from the item 140. That is, the image sensor's surface, which is defined by a first side 116 that is generally parallel to the previously-mentioned first direction or axis, and a second side 118 that is generally parallel to the previously-mentioned second direction or axis, is being used to image the item 140. Accordingly, all pixels of the sensor array which makes up the image sensor 114 are active, used and exposed to produce and output digital image data corresponding to the item 140. During the imaging operation one or more of various digital imaging processes known in the art may be performed such as automatic focusing (AF), automatic white balance (AWB), automatic exposure (AE), image stabilization and the like.

The digital image data of the item 140 is then processed (e.g., using the image sensor 114 in cooperation with a processing module such as an image signal processor) to, as indicated by arrow 160, perform at least one operation of reproducing, rendering or displaying an image 130 on the display 120 for presentation to and viewing by a user of the mobile electronic device. As shown, the display 120 has a display area defined by a first side 122 that is generally parallel to the previously-mentioned first direction or axis, and a second side 124 that is generally parallel to the previously-mentioned second direction or axis. However, due to differences in aspect ratios of the image sensor 114 and the display 120 the image 130 of item 140 occupies only a portion of the display 120 defined by the second side 124 and a portion 126 of the first side 122. That is, as shown in FIG. 1 the image 130 is bookended between non-display strips 123 and 125 which are configured at the opposing left and right sides of the display 120.

An example is now provided for the imaging operation shown in FIG. 1. In this example the image sensor is a five megapixel sensor with a first side (corresponding to side 116) being 2592 pixels and a second side (corresponding to side 118) being 1944 pixels such that the sensor has an aspect ratio of 4:3, whereas the display is a screen configured with a 16:9 aspect ratio defined by first side (corresponding to side 122) being 640 pixels and second side (corresponding to side 124) being 360 pixels. Accordingly when employing an entire area of the image sensor a factor of scaling equals 0.19 as is determined by dividing the width 126 (i.e. 480 pixels) of image 130 by the width 116 (i.e. 2592 pixels) of the sensor 114.

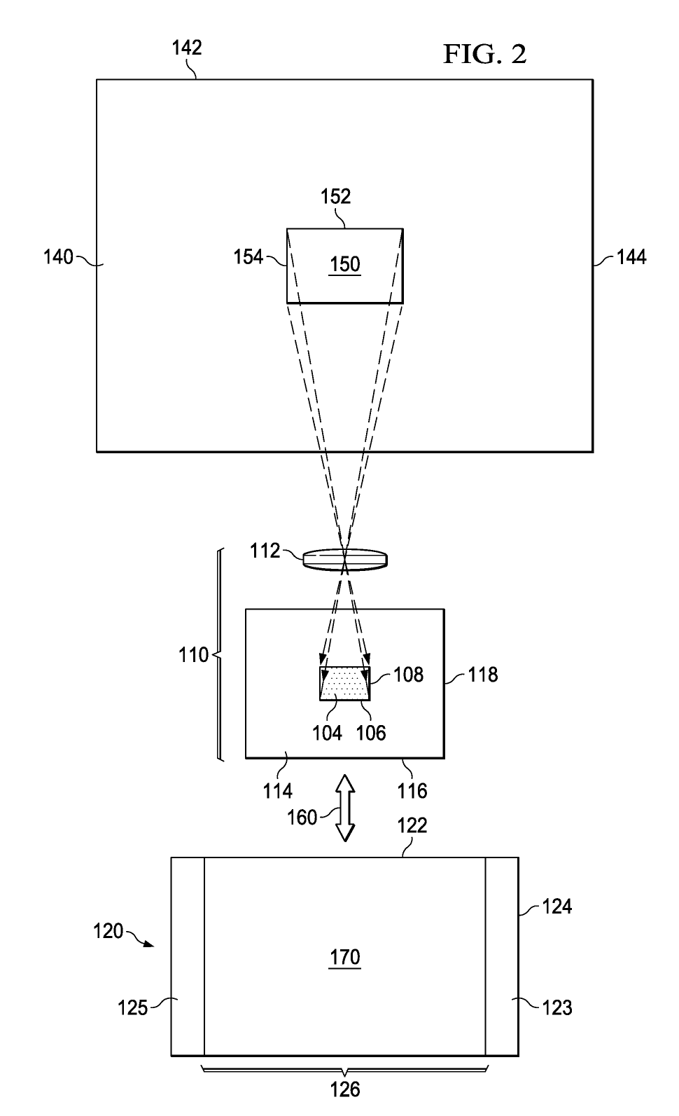

Turning now to FIG. 2 another operation of the present magnification method is depicted. The operation shown in FIG. 2 is performed after or subsequent to the operation of FIG. 1, and involves controlling an imaging module (e.g., the image sensor 114 or a digital image processor/DSP) to reduce or decrease the active resolution that is being used to create digital image data for displaying or reproducing a magnified image of the item 140. Because a reduced or decreased active resolution is employed, a magnified or enlarged image can be generated and displayed more quickly and without depleting or taxing processing resources of the mobile electronic device.

In one implementation, the operation of reducing or decreasing the active resolution may be accomplished by adjusting the active imaging area (i.e., a pixel area that is being used to image the item of interest) of the image sensor to be smaller than the effective area (i.e., an entirety) of the image sensor. Alternatively, in another implementation, the operation of decreasing the active resolution is accomplished by controlling the image signal processor. However, when the operation of decreasing the active resolution is performed by the image sensor instead of the image signal processor, the frame rate can be increased since the period of the input signal is decreased. As shown in FIG. 2, the effective area of the image sensor 114 is the same or substantially similar as shown in FIG. 1. Furthermore, the active imaging area 104 of image sensor 114 is defined by a first side 106 and a second side 108. When the active imaging area is decreased in size from being the entire (or effective) area of the image sensor, this decrease results in a proportionately sized portion of the item 140 being imaged. Additionally, this operation of decreasing the size of the active imaging area results in a new, smaller frame being rendered up to a larger output frame size. On account of this decreasing operation, instead of imaging an entirety of the item 140, only a portion 150 (defined by first side 152 and second side 154) of the item 140 is imaged and rendered and/or displayed (relative to arrow 160) on the display 120 as image 170 that shows only the portion 150. The number of active pixels of the image sensor 114 may be reduced or decreased by selectively using or activating only a specific area of the sensor for example, a central area such as portion 104 shown in FIG. 2. Alternatively, the active pixels of the image sensor may be reduced or decreased by selectively deactivating a rectangular ring-shaped area of the sensor while maintaining an active central rectangular area such as portion 104. Furthermore although the active pixels or active imaging area of the sensor is shown to be a central portion 104, nevertheless the active pixels or active imaging area may be configured elsewhere such as in a corner of the sensor 114, for example originating at pixel coordinate (x, y)=(0, 0).

An example is now provided for the imaging operation shown in FIG. 2. In this example, pixel dimensions are the same as given in the previous example given with respect to FIG. 1. However, the active pixel area or active imaging area 104 of the sensor is defined by active first dimension (corresponding to side 106) being 240 pixels and active second dimension (corresponding to side 108) being 180 pixels. Accordingly it can be appreciated that the reduction of the active imaging area results in a higher narrowing factor (NF), where additional narrowing of the field of view (FOV) results in a higher NF. To this end a factor of magnification is achieved when image narrowing and scaling operations are performed relative to a rendering/displaying operation. The magnification factor (MF) can be determined by:

$$M F = NF \times S F where NF is the previously \text{-} mentioned narrowing factor that is determined by the equation = Min [ ( first side 116 \div active first side 106 ) , ( second side 118 \div active second side 108 ) ] = Min [ ( 2592 \div 240 ) , ( 1944 \div 180 ) ] = 10.8 and S F is a scaling factor .$$

Additionally a factor of scaling in this example is 2.00 as is determined by dividing the image width of 480 pixels by 240 pixels which is the active pixel width (i.e., active first side 106) of sensor 114. To this end, the MF is 21.6 (=10.8×2.0). A higher magnification factor (MF) may be achieved by employing a scaling block between an output of the image sensor 114 and an input of the display 120. However, in certain instances a scaling block may be used to further increase the MF only if the field of view (FOV) is further reduced. Increasing the scaling factor may be performed via a real-time (or near real-time) upscaling process. Furthermore, the real-time upscaling process may be or employ a bicubic (or better) upscaling process or algorithm that is executed for example in an image signal processor of the mobile electronic device.

In view of the foregoing, image magnification occurs relative to narrowing and scaling operations by transitioning between the imaging operation of FIG. 1 during which an entire resolution or pixel area of the image sensor is used, and the imaging operation of FIG. 2 during which a decreased resolution or smaller active pixel area is used. The present method may further include a displaying operation (relative to arrows 160 shown in FIGS. 1 and 2) during which magnified images are reproduced or shown in a substantially continuous or streaming manner (e.g., as per a digital camera live-preview/viewfinder mode). Furthermore if at least one of the camera module 110 and an image signal processor supports continuous (or otherwise sustained) autofocus functionality, an autofocus search may be performed continuously for maintaining clear focus of the item being magnified. However, if non-continuous autofocus functionality is present, an autofocus search may initially be performed when the camera module or image signal processor starts to output the stream of images/frames. Then upon direction from a user of the device during the autofocus search the camera lens is moved to a position that is calculated by the autofocus algorithm and is maintained at that position until a subsequent user input is received.

The present method may further include an operation of illuminating the item to be imaged by using a flash of the mobile communication device. The flash (e.g., an LED or other illuminant known in the art) may emit light in a sustained manner during one or more of the magnification operations (e.g., as depicted in FIGS. 1 and 2). Furthermore, the flash may be automatically activated and deactivated relative to the magnification operations. In addition, the present method may include one or more operations such as: performing an image-stabilization process on the magnified image; performing edge enhancement on the magnified image; capturing and/or storing a frame of a magnified image that is being produced; and adjusting an aspect ratio of the active imaging area to produce an output with a desired format. To further assist a user who is employing the device, the present method may include one or more operations of optical character recognition (OCR), intelligent character recognition (ICR), optical mark recognition (OMR), and/or text-to-speech (TTS).

Turning now to FIG. 3 an example output or result of the present magnifying method is described. As shown in FIG. 3 an item 300 to be imaged is a paper or display bearing text 310. More specifically the text 310 is to be magnified by device 350 that employs the imaging method which was previously described relative to FIGS. 1 and 2. That is, the device 350 includes a processor configured to execute instructions, which are stored in a tangible medium such as a magnetic media, optical media or other memory, that cause a decrease of an active resolution (e.g., active pixel area or active imaging area of an image sensor) of the device. Accordingly, as shown in FIG. 3 a portion of the text 310 is imaged by camera 370 such that a magnified or enlarged version of the portion of the text 310 is shown on an active display area 380. That is, the text “The quick brown fox jumps over the lazy dog.” on item 300 is imaged and magnified using the device 350 such that an effective display area 360 that is smaller than the active display area 380 shows text “over the lazy” in a size that is enlarged relative to the printed text 310.

The device 350 may perform one or more digital camera functions known in the art (e.g., image stabilization, AF, AE, AWB) when processing and displaying the image. Furthermore, in order to process (and output or display) the image in a desired output format (e.g., 720p, 1080i/1080p, etc.) an aspect ratio of the active area of the imaging sensor may be adjusted such that the aspect ratio of the active area corresponds substantially to the desired output format. For example, the aspect ratio of the active area may be changed to 16:9 (e.g., from 4:3 or another aspect ratio) such that the images/frames being output and/or displayed by the device 350 are high definition, 720p mode. Moreover the enlarged or magnified version of the image which is being displayed may be captured by and/or stored in the device 350, for example in an integral memory (RAM, ROM) or removable memory.

Turning now to FIG. 4, an apparatus is provided with respect to another aspect of the present disclosure. In particular, the apparatus is configured to perform the operations of the previously-described image magnification method. As can be appreciated, the apparatus shown in FIG. 4 may be embodied as the device 350 of FIG. 3, or a device that comprises camera module 110 and display 120 shown in FIGS. 1 and 2. Although the apparatus of FIG. 4 is a mobile communication device 400 such as a wireless (cellular) phone, camera phone, smart phone etc., nonetheless the apparatus may be configured as various electronic devices which include or otherwise employ a display and at least one of a camera, a camera module, and an imaging device. That is, the apparatus may alternatively be a portable computer such as a laptop, netbook, tablet computer, a portable music/media player, a personal digital assistant (PDA) or the like.

As shown in FIG. 4, the example mobile communication device 400 includes a processor 410 for controlling operation of the device. The processor 410 may be a microprocessor, microcontroller, application specific integrated circuit (ASIC), field programmable gate array (FPGA) or the like that is configured to execute or otherwise perform instructions or logic, which may be stored in the processor 410 (e.g., in on-board memory) or in another computer-readable storage medium such as a memory 420 (e.g., RAM, ROM, etc.) or a removable memory such as a memory card 430 or SIM 440. The processor 410 communicates with other components or subsystems of the device 400 to effect functionality including voice operations such as making and receiving phone calls, as well as data operations such as web browsing, text-based communications (e.g., email, instant messaging (IM), SMS texts, etc.), personal information management (PIM) such as contacts, tasks, calendar and the like, playing or recording media (e.g., audio and/or video), etc.

As shown the device 400 is configured to communicate, via wireless connection 402 and network 404, with an endpoint 406 such as a computer hosting a server (e.g., enterprise/email server, application server, etc.). The network 404 and wireless connection 402 may comply with one or more wireless protocols or standards including CDMA, GSM, GPRS, EDGE, UMTS, HSPA, LTE, WLAN, WiMAX, etc. Accordingly to facilitate or otherwise enable transmission and receipt of wireless signals or packets encoded with messages and/or data, the device 400 includes various communication components coupled, linked or otherwise connected (directly or indirectly) with the processor 410. As shown, device 400 includes a communication subsystem 450 that includes various components such as a radio frequency (e.g., cellular) RF transceiver, power amplifier and filter block, short-range (e.g., near field communication (NFC), Bluetooth® etc.) transceiver, WLAN transceiver and an antenna block or system that includes one or more antennas.

As is further illustrated in FIG. 4, the device 400 includes a user interface subsystem 460 with a display 462 and a user input 464. The display 462 may be various types of display screens known in the art including for example TFT, LCD, AMOLED, OLED, and the like for rendering or reproducing images, icons, menus, etc. The user input 464 may include one or more buttons, keys (e.g., a QWERTY-type keyboard), switches and the like for providing input signals to the processor 410 such that a user of the device 400 can enter information and otherwise interact with or operate the device 400. Although the display 462 and user input 464 are shown as being separate or distinct components, nevertheless the display and user input may be combined, integral or unitary in other embodiments. That is, the display and user input may be configured as a unitary component such as a touch-sensitive display on which “soft” buttons or keys are displayed for the user to select by pressing, tapping, touching or gesturing on a surface of the display.

The device 400 as further shown in FIG. 4 also includes a power and data subsystem 470 that includes components such as a power regulator, a power source such as a battery, and a data/power jack. To enable audio and video functionality of the device 400, an audio/video subsystem 480 is provided. Various discrete audio components of audio/video subsystem 480 are coupled, linked or otherwise connected (directly or indirectly) with the processor 410. The audio/video subsystem 480 includes audio components such as an audio codec for converting signals from analog to digital (AD) and from digital to analog (DA), compression, decompression, encoding and the like, a headset jack, a speaker and a microphone.

With respect to the present magnifying methods, to enable camera-type functionality of the device 400 various imaging components are included in the audio/video subsystem 480. The discrete imaging components are coupled, linked or otherwise connected (directly or indirectly) with the processor 410. As shown, the audio/video subsystem 480 includes an image signal processor 490 (ISP as shown), a camera module 492 and flash 494. Although FIG. 4 shows the ISP 490 to be separate from or external to the processor 410, the ISP and processor 410 may be combined, unitary or integrated in a single processing unit. Furthermore, although one ISP 490 is shown in FIG. 4, some devices 400 or processors 410 may include more than one ISP. To this end, an embodiment of device 400 may include a processor 410 with an integrated ISP, and a second ISP that is separate and external to the processor 410. The image signal processor 490 (e.g., a digital signal processor (DSP) chip) is provided to control the camera module 492. The camera module 492 (which may be similar to camera module 110 shown in FIGS. 1 and 2) may include various lenses as well as an imaging device such as a CCD or CMOS sensor. In some instances the image signal processor 490 may also control the flash 494 (e.g., an LED or other illuminant) for illuminating an item, object or scene that is being photographed. However, the flash 494 may alternatively be controlled by the processor 410 directly. The flash 494 may be controlled such that it is activated and deactivated automatically in relation to one or more of the operations of the present magnifying method, such as for example the operation of reducing the active resolution that is being output from an imaging module. Furthermore, the flash 494 may be controlled for sustained illumination during the present method. The image signal processor 490 is also configured to process information from the camera module 492, for example image (pixel) data of a photographed/imaged item. The image signal processor 490 may be configured to perform image processing operations known in the art such as automatic exposure (AE), automatic focusing (AF), automatic white balance (AWB), edge enhancement and the like. These image processing operations may be performed by the image signal processor 490 based on information received from the processor 410 and the camera module 492.

In view of the foregoing description it can be appreciated that the example device 400 may be embodied as a multi-function communication device such as a camera phone, smart phone, laptop, tablet computer or the like.

In general the present methods and apparatuses provide for achievement of a higher frame/sampling rate such that subsequent display of the magnified content to the end user is optimized. In particular, images produced by using decreased active resolution of the present methods provide increased motion smoothness, decreased motion blur and consequently increased clarity. Additionally, the present methods provide for sustained illumination of the item or object being imaged as opposed to the aforementioned viewfinder display functionality for still and moving picture-taking modes in which an illuminant of the mobile communication device does not automatically activate and deactivate. In further contrast to conventional image magnification methods such as digital zoom, if the output frame rate is high enough when cropping is performed all cropping may be done by the image signal processor (ISP). Otherwise cropping may be partially or completely performed by the image sensor, and the output frame rate can be increased when cropping is performed by the image sensor.

Moreover, the present methods and apparatuses provide for a substantially higher degree of image stabilization and a substantially higher degree of magnification when compared to the aforementioned image viewfinder mode (during which image stabilization is not always supported), and the aforementioned video viewfinder mode. Finally, in contrast to the aforementioned image and video viewfinder modes in which upscaling is not supported, the present methods provide for real-time bicubic (or better) upscaling to optimize the subsequent display of the magnified content to the end user; in particular, with increased clarity.

Various embodiments of this invention are described herein. In view of the foregoing description and the accompanying Figures, example methods and apparatuses for magnifying items is provided. However, these embodiments and examples are not intended to be limiting on the present invention. Accordingly, this invention is intended to encompass all modifications, variations and equivalents of the subject matter recited in the claims appended hereto as permitted by applicable law.

What is claimed is:

1. A magnifying method performed by a mobile electronic device, the method comprising:
decreasing an active resolution of an imaging module of the mobile electronic device while imaging an item;
processing a decreased active resolution being output by the imaging module to produce a magnified image of the portion of the item;
increasing a scaling factor of the magnified image to further magnify the magnified image; and
outputting frames to display a magnified version of the portion of the item.

2. The method of claim 1 wherein the imaging module is an image sensor or an image signal processor.

3. The method of claim 1 further comprising:
using a flash of the mobile communication device to illuminate the item in a sustained manner.

4. The method of claim 3 wherein the operation of using the flash further comprises at least one of automatically activating and deactivating the flash.

5. The method of claim 1 further comprising at least one of:
performing an image-stabilization process on the magnified image; and
performing edge enhancement on the magnified image.

6. The method of claim 1 further comprising at least one of:
performing optical character recognition (OCR) relative to the magnified image;
performing intelligent character recognition (ICR) relative to the magnified image;
performing optical mark recognition (OMR) relative to the magnified image; and
performing text-to-speech (TTS) relative to the magnified image.

7. The method of claim 1 wherein increasing the scaling factor comprises using a real-time upscaling process that is a bicubic or better upscaling process.

8. The method of claim 1 further comprising:
capturing at least one frame of the magnified image; and
storing or outputting the captured frame of the magnified image.

9. The method of claim 2 wherein the imaging module is an image sensor and wherein the operation of decreasing the active resolution comprises decreasing the active area of the image sensor.

10. The method of claim 9 wherein an aspect ratio of the active area corresponds to a desired output format.

11. A mobile electronic device comprising:
an imaging module; and
a processor configured to execute instructions for:
decreasing an active resolution of the imaging module while imaging an item;
processing the decreased active resolution being output by the imaging module to produce a magnified image of the portion of the item;
increasing a scaling factor of the magnified image to further magnify the magnified image; and
outputting frames for displaying a magnified version of the portion of the item.

12. The device of claim 11 wherein the imaging module is an image sensor or an image signal processor.

13. The device of claim 11 wherein the processor is further configured to execute instructions for controlling a flash of the mobile electronic device to illuminate the item in a sustained manner.

14. The device of claim 13 wherein the operation of controlling the flash further comprises at least one of automatically activating and deactivating the flash.

15. The device of claim 11 wherein the processor is further configured to execute instructions for at least one operation of:
performing an image-stabilization process on the magnified image; and
performing edge enhancement on the magnified image.

16. The device of claim 11 wherein the processor is further configured to execute instructions for at least one operation of:
performing optical character recognition (OCR) relative to the magnified image;
performing intelligent character recognition (ICR) relative to the magnified image;
performing optical mark recognition (OMR) relative to the magnified image; and
performing text-to-speech (TTS) relative to the magnified image.

17. The device of claim 11 wherein the operation of increasing the scaling factor comprises using a real-time upscaling process that is a bicubic or better upscaling process.

18. The device of claim 11 wherein the processor is further configured to execute instructions for:
capturing at least one frame of the magnified image; and
storing or outputting a captured frame of the magnified image.

19. The device of claim 12 wherein the imaging module is an image sensor and wherein the operation of decreasing the active resolution comprises decreasing the active area of the image sensor.

20. The device of claim 11 wherein an aspect ratio of the active area corresponds to a desired output format.
